(19) United States
(12) Patent Application Publication
(10) Pub. No.: US 2014/0129662 A1
(43) Pub. Date: May 8, 2014

(54) SYSTEMS AND METHODS FOR FACILITATED TRANSACTIONS

(71) Applicant: Big Day Weather, LLC, Madison, WI (US)

(72) Inventors: Charles E. Sandy, Madison, WI (US); Neal J. Sandy, Madison, WI (US); Paul A. Sandy, Madison, WI (US)

(73) Assignee: Big Day Weather, LLC, Madison, WI (US)

(21) Appl. No.: 14/070,185

(22) Filed: Nov. 1, 2013

Related U.S. Application Data
(60) Provisional application No. 61/721,904, filed on Nov. 2, 2012.

(51) Int. Cl. H04L 12/58

(52) U.S. Cl. CPC H04L 51/24
USPC 709/207

(57) ABSTRACT

The invention described herein relates to systems and methods for facilitating transactions between a transaction service, one or more clients, one or more computers, and sources of information such as meteorologists and weather databases.

The present application claims priority to U.S. Provisional Patent Application Ser. No. 61/721,904, filed Nov. 2, 2012, the disclosure of which is herein incorporated by reference in its entirety.

### FIELD OF THE INVENTION

The invention described herein relates to systems and methods for facilitating transactions between a transaction service, one or more clients, one or more computers, and sources of information such as meteorologists and weather databases.

### BACKGROUND

Individuals plan and attend a variety of different events and activities including but in no way limited to birthday parties, weddings, sporting events, concerts, holidays, recreation events, and outings. On or before the day of the event, things such as weather, location, and timing often change. For some events, weather can be a critical factor. As such, individuals attending events often check general weather forecasts (e.g., forecasts for a given zip code) and adjust the event according to the forecast.

Adjusting events according to general weather forecasts often leads to events being unexpectedly rained upon or unnecessarily cancelled due to inaccurate forecast data. Furthermore, any change in the event location, date, or time often involves an inefficient process of communication wherein guests haphazardly contact other guests. Often, some individuals fail to receive notification that an event has been cancelled or changed due to faulty communication. Anxiety and disappointment often accompany important planned events.

What is needed are convenient and reliable methods and systems for providing weather forecast and other information to event guests and various third parties.

### SUMMARY OF THE INVENTION

The invention described herein relates to systems and methods for facilitating transactions between a transaction service, one or more clients, one or more computers, and sources of information such as meteorologists and weather databases.

For example, in some embodiments, provided herein are methods for facilitating event planning comprising one or more or all of the steps of: a) establishing a transactional relationship with a customer, b) soliciting information regard a date, time, location, and guest list for a future event from the customer, c) storing the solicited information in a database, d) associating the solicited information with a URL (e.g., a unique URL), e) providing one or more individuals on the guest list with the URL, f) permitting the one or more individuals to use the URL to opt-in to a service plan, and g) delivering information related to the future event to one or more or all of the individuals that opt-in. In some embodiments, the transactional relationship is established using an app or web site. In some embodiments, the information sent to individuals who opt-in includes one or more of the following: weather forecasts, severe weather alerts, advertisements, instructions, and pictures.

Further provided are methods of providing personalized weather information comprising one or more or all of the steps of: a) soliciting personalized date, time, and location information about a future event from a customer, b) associating the information with the customer or another individual designated by the customer, c) storing of the personalized information in a database, d) aggregating weather forecast information related to the future event information provided by the customer, and e) disseminating the weather forecast information to said customer or one or more individuals designated by said customer. In some embodiments, the event is a wedding, sporting event, concert, party, or gathering. In some embodiments, the weather forecast information is obtained from a meteorologist, database, or algorithm. In some embodiments, the one or more individuals opt-in to receive the disseminated information by email, text message, social networking site, or directly using an app. In some embodiments, the weather forecast information is disseminated by email, pushes, text messages, and telephone communications. In some embodiments, a meteorologist is available to speak with and provide weather forecast information to said customer on and before the event day.

Also provided herein are methods of providing personalized weather information comprising one or more or all of the steps of: a) obtaining personal information related to a future event including a date, time, and location from a client, b) associating the information with a URL, c) informing the client of the URL related to the information, d) allowing individuals who access the URL to opt-in to notifications, e) using the information in conjunction with a meteorologist and/or weather database to develop a personalized weather forecast, and f) sending the personalized weather forecast to the client and/or the individuals who have opted-in.

Further provided herein are methods for facilitating event planning comprising one or more of all of the steps of: a) establishing a transactional relationship with a service provider, b) sending information regard a date, time, location, and guest list for a future event to said service provider, wherein said guest list provides identifies and contact information for one or more individuals that are to be given an option to opt-in to a service plan to receive information related to the future event, c) receiving a URL from said service provider associated with said sent information, and d) receiving information related to the future event from said service provider.

Further provided herein are methods for providing information to one or more individuals associated with an event comprising one or more or all of the steps of: a) receiving a guest list provided by a customer to a service provider, wherein said guest list provides identification and contact information for one or more individuals that are to be given an option to opt-in to a service plan to receive information related to the event, b) receiving opt-in information from said service provider identifying members of said customer list that have opted-in to receive said information related to the event, and c) sending said information related to the event to said service provider to be associated with a URL or providing said information related to the event to said members of said customer list that have opted-in.

Further provided herein are systems (e.g., computer systems and associated software) comprising a computer processor configured to carry out any of the methods described herein.

### DEFINITIONS

To facilitate understanding of the invention, a number of terms and phrases are defined below:

As used herein, the term “transaction service” refers to an entity that facilitates transactions between two or more parties. It is contemplated that these transactions can include, but are not limited to, exchanges of information, material goods, and resources.

As used herein, the term “front end” refers to components that are configured to directly interact with users. Some front end components collect input in various forms and process the input to conform to the back end components.

As used herein, the term “back end” refers to components which receive information directly or indirectly from front end components.

As used herein, the term “push” refers to an information dissemination technology used to send data to users over a network. In contrast to World Wide Web (a “pull” technology), in which the client browser must request a Web page before it is sent, push protocols send the informational content to the user computer or device automatically, typically based on information pre-specified by the user. This term can also refer to the action of sending a push.

As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the term “web site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “HTML” refers to HyperText Markup Language which is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

As used herein, the term “HTTP” refers to HyperText Transport Protocol which is the standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

As used herein, the term “database” refers to one or more structured sets of persistent data, usually associated with software to update and query the data. A simple database might be a single electronic file containing many records, each of which is structured using the same set of fields.

As used herein, the term “file” refers to an abstract data object made up of an ordered sequence of data bytes stored on a storage area or device or a symbolic name by which a data object is identified. A file may include one or more data blocks.

As used herein, the term “text message” refers to messages comprising words, symbols, icons, and combinations thereof.

As used herein, the term “URL” refers to Uniform Resource Locator which is a unique address that fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

As used herein, the term “API” stands for Application Programming Interface and is used to refer to a set of functions that can be called from an application program to access features of another program.

As used herein, the term “message” encompasses data that is sent and received by one or more computer programs. In a broader sense, the term may refer to any information which is transmitted from one entity to another.

As used herein, the term “web-based” encompasses any tool, component, or service which is accessed from outside of the local area network of a user or tenant which operates on that network. The term “web-based” is also used to refer to systems employing primarily a browser, an Internet connection, and a computer to obtain substantially complete access to that system.

As used herein, the term “forecast” refers to predictions and/or estimations made about the future. The term is also used to refer to predictions of weather conditions based on analysis of meteorological data. Sometimes, the latter type of forecast is referred to as a “weather forecast.”

As used herein, the term “personalized” includes wide variations on the theme of personalization, including both of the following: systems in which an entity has a transmission channel by which to express preferences or to request information of a specific type; and systems in which an entity can select among a plurality of simultaneously distributed sets of information, in which the particular information presented to the recipient is responsive to individual or personal preferences or selections (instead of the information being identically presented to a mass audience). In one broad sense, the term “personalized” refers to anything that is tailored to meet the needs of a particular individual rather than a mass audience.

As used herein, the term “event” refers to anything that occurs in a certain location at a certain time. The term includes, but is in no way limited to, weddings, outdoor activities such as fishing or hiking trips, parties, sporting events, informal gatherings, trips, activities, and outings. The term “event day” is used to refer to the day of the event. In a broader sense, the term “event day” can refer to a specified interval of time encompassing the event.

As used herein, the term “meteorologist” refers to an entity that forecasts and/or reports weather conditions. In some embodiments, a meteorologist is a person with training and experience in the science of weather forecasting.

As used herein, the terms “guest,” “event guest,” “activity guest,” “event attendees,” and similar terms are used to describe entities attending events. Such entities can include people and businesses.

As used herein, the term “customer” refers to an entity buying or entering into a contract or other agreement to buy a product or service. The term “client” is sometimes used interchangeably with the term “customer,” but the term “client” can also be used in the broader sense to refer to individuals using a product or service.

As used herein, the term “application” is intended to refer generally to an experience of appearance and behavior engendered by a computing platform. An application is commonly authored in a source code language using an authoring environment, the source code being used to generate an executable version of the application for deployment to a computer platform to realize the desired experience. The abbreviated term “app” is sometimes used to refer to an application.

As used herein, the term “computer” can refer to a device or system capable of accepting a structured input, processing the structured input according to prescribed rules, and producing results of the processing as output. Examples of a computer include: a computer, a tablet computer, a digital phone, a general purpose computer, a supercomputer, a mainframe, a super mini-computer, a workstation, a micro-computer, a server, an interactive television, and application-specific hardware to emulate a computer and/or software. A computer can have a single processor or multiple processors which can operate in parallel and/or not in parallel. A computer also refers to two or more computers connected together via a network for transmitting or receiving information between the computers. An example of such a computer includes a distributed computer system for processing information via computers linked by a network. The term “computing device” can be used similarly to the term “computer.”

### DESCRIPTION OF THE FIGURES

FIG. 1 depicts a diagram of connections between the entities involved in the transaction systems and methods of one embodiment of the present invention.

FIG. 2 depicts an implementation of the transaction systems and methods of one embodiment of the present invention. In this embodiment, an event or activity participant (e.g., a bride) transacts with a transaction service.

FIG. 3 depicts an implementation of the transaction systems and methods of another embodiment of the present invention. In this embodiment, an event or activity planner (e.g., a wedding planner) transacts with a transaction service.

FIG. 4 depicts an implementation of the transaction systems and methods of another embodiment of the present invention. In this embodiment, an event or activity planner (e.g., a concert promoter or sporting event manager) transacts with a transaction service.

FIG. 5 depicts an implementation of the transaction systems and methods of another embodiment of the present invention. In this embodiment, an individual begins a transaction with a transaction service.

### DETAILED DESCRIPTION OF THE INVENTION

The present invention provides a transaction service and system that provides electronic entity-to-entity transaction methods. These systems and methods allow businesses to facilitate transactions with their customers. For example, the present invention provides systems and methods for the delivery of personalized weather forecast information to customers and other individuals.

In some embodiments, the present invention comprises a transaction system wherein the system receives personalized information from an entity, transmits the information to another entity, stores the information, and provides a variety of services to the first entity. In a further embodiment, the information provided by the first entity is temporal and/or positional information tied to a future activity. In some embodiments, the services provided to the first entity include the delivery of messages to third parties designated by the first entity, and the provision of situational information relating to the temporal and/or positional information provided by the first entity. In some embodiments, the situational information is personalized weather forecasts, expert consultation, advertisements, warnings, inspirational quotes, pictures, price quotes, and other digital and/or physical information.

In some embodiments, the present invention comprises a method of obtaining personalized information, wherein an individual provides temporal and positional information related to a future activity to a computer-implemented application and then receives personalized information from an entity related to the application. The personalized information provided to the application can include the date, time, and location of an activity (e.g., a wedding or other event). The personalized information from the entity related to the application can include personalized weather forecasts, expert consultation, advertisements, warnings, inspirational quotes, pictures, price quotes, and other digital and/or physical information.

In some embodiments, electronic transactions are performed with a variety of devices including, but not limited to, tablet computers (e.g., IPAD), phones (e.g., IPHONE), laptop computers, desktop computers, and other devices capable of performing computational tasks. Devices capable of being used in the present invention likely comprise data storage components such as random access memory or read only memory, data processing components capable of storing and retrieving data, and components capable of providing input and/or output to users.

In some embodiments, data from the transaction are stored on computer readable medium (e.g., DVDs, CDs, hard disk drives, magnetic tape and servers for streaming media over networks). In other embodiments, the transaction data are stored on computer memory or a computer memory device.

In some embodiments, the computer system comprises computer memory or a computer memory device and a computer processor. In some embodiments, the computer memory (or computer memory device) and computer processor are part of the same computer. In other embodiments, the computer memory device or computer memory are located on one computer and the computer processor is located on a different computer. In some embodiments, the computer memory is connected to the computer processor through the Internet or other electronic communication network. In some embodiments, the computer memory is on a computer readable medium (e.g., floppy disk, hard disk, compact disk, DVD, etc). In other embodiments, the computer memory (or computer memory device) and computer processor are connected via a local network or intranet.

In some embodiments, “a processor” may in fact comprise multiple processors in communication with each other for carrying out the various processing tasks required to reach the desired end result. For example, the computer of an intermediary service provider may perform some processing and the computer of a customer linked to the intermediary service provider may perform other processing.

In some embodiments, the computer system further comprises computer readable medium with the transaction application stored thereon. In further embodiments, the computer system comprises the computer memory and computer processor, and the transaction application is located on the computer memory, and the computer processor is able to read the transaction application from the computer memory (e.g., ROM or other computer memory) and perform a set of steps according to a transaction application. In certain embodiments, the computer system may comprise a computer memory device, a computer processor, an interactive device (e.g., keyboard, touchscreen, mouse, voice recognition system), and a display system (e.g., monitor, speaker system, etc.).

In some embodiments, the present invention provides a method of transaction including (1) providing a user interface capable of receiving user information, including information for identifying the user; (2) providing an application linked to the user interface, and including information and defined rules for (a) accepting personal information from an individual, (b) processing the information, and (c) storing the information; (3) providing a computer system for operating the transaction application, wherein the computer system includes computer memory and a computer processor, (4) providing a hosted electronic environment operably linked to the computer system; (5) displaying the user interface on the hosted electronic environment; (6) receiving user information by way of the user interface; and (7) processing the user information with the transaction application to generate a personalized profile and/or unique URL.

In some embodiments of the systems and methods of the present invention, the user interface is a written document capable of being viewed by a user. In further embodiments, the user interface is a telephone, modem, or other electronic device capable of receiving responses from a user (e.g., responsive to pre-recorded telephone message of questions or questions presented by an operator). In some embodiments, the user interface is a graphical user interface (e.g., a user interface screen presented on a computer monitor or screen of a handheld device).

In some embodiments of the methods of the present invention, the user information is received by way of the user interface. While it would be possible to receive user information by receiving oral communications, or by receiving a written document from a user, in some embodiments, the receipt of the user information is by way of electronic communication (e.g., over telephone lines, cable lines, wireless networks, or a broadcast electronic communication), for example, by information entered into a web site or device application.

In some embodiments of the methods of the present invention, user information is processed with the transaction application to generate a unique user profile. In some embodiments, the transaction application is operably linked to the computer processor such that the transaction application is able to process the user information. In some embodiments, the transaction application is physically located in the same computer as the computer processor. In other embodiments, the transaction application is in a different computer than the computer processor and the transaction application and computer processor are operably linked (e.g., there is an electronic connection between the computer processor and the transaction application). In some embodiments, the electronic connection is selected from phone lines, cable lines, wireless networks, broadcast transmission, or combinations thereof.

In some embodiments, the present invention provides systems for the direct or indirect sharing of information among entities and components such as the following:
1.) A transaction service that controls the transaction in full or in part,
2.) A database or other aggregation of information such as a third-party weather service,
3.) A meteorologist or other expert person capable of accumulating and delivering information,
4.) A customer or client (e.g., an individual who seeks information from the transaction service),
5.) Other entities who could play a part in the transaction (e.g., individuals specified by the customer to be recipients of the information), and
6.) One or more advertisers.

The systems and methods described herein provide many advantages, including managing risk and liability for bad event outcomes (e.g., weather related complications and disasters). Thus, they systems and methods provide a mechanism to manage insurance costs and liability costs for planners and event management organization and/or to improve efficiency by insurers. For example, the systems and methods mitigate event management liability due to severe weather by allowing event managers to provide guests or other participants with an easy-to-use weather alert feature (e.g., for free or for minimal cost). Guests who do not opt-in to the feature likely will have a more difficult time proving management negligence.

Certain illustrative embodiments are described in more detail below, in particular focusing on weddings and weather related events. It should be understood that the invention is not limited to these particular embodiments.

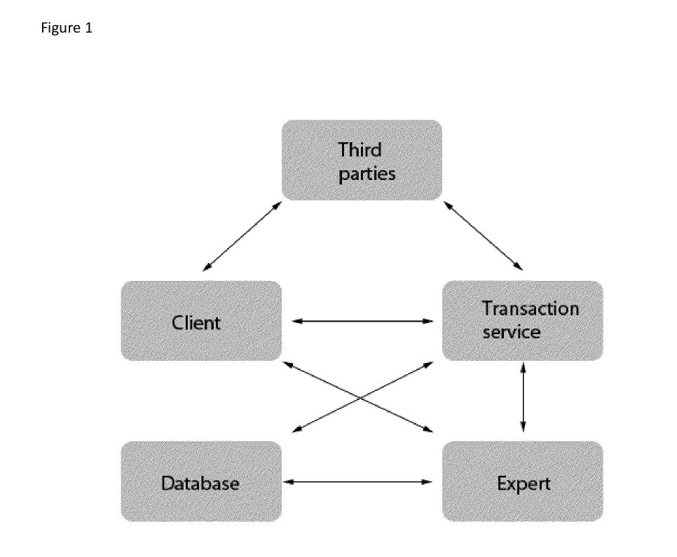

FIG. 1 depicts a diagram of connections between the entities involved in the transaction systems and methods of one embodiment of the present invention. In some embodiments, a customer and a transaction service contract to do business with one another. The customer then provides personalized information to the transaction service who then parses the personalized information and inputs it into a database. In some embodiments, the transaction service uses third-party services, computer programs, or other methods for analyzing the data. The transaction service then aggregates information specific to the personalized information supplied by the customer. Such specific information can be gathered from individuals with expertise, computer models, and other sources. In some embodiments, the specific information is relayed to the customer who supplied the personalized information or to other individuals. In some embodiments, the transaction service is free for the customer if he or she opts-in to receive advertisements. In other embodiments, the transaction service is purchased and the customer is able to opt-out of advertisements.

In some embodiments, upon receipt and processing of the personalized information, the transaction service provides the customer with a unique URL. This URL can be used by the customer or individuals designated by the customer to access, via the Internet, specific information related to the personalized information provided by the customer. In some embodiments, individuals are able to opt-in to push messages by the transaction services. Such push messages can include weather information, logistical information, or other types of communications.

In some embodiments, the communications to the participants and/or planners can occur via multiple methods including website communications, email, text, social media (e.g., FACEBOOK, TWITTER, etc.), or directly to an app. These communications can arrive at multiple devices including but in no way limited to computers, phones, smart phones, and tablet computers. In some embodiments, users are able to create events, including setting weather forecast and alerting features, for their guests and share them via any communication modality, including social media.

In some embodiments, the participants, planners, or others have the option of selecting the type, nature, and timing of information and alerts provided. For example, in some embodiments, people traveling to an event away from their home may not want alerts for the location of the event on a continuous basis, yet still want them the day of the event when they will be at the location. In some embodiments, users can select an option to only receive weather alerts on the day of the event.

In some embodiments, as guests opt-in to alert features, they also are either automatically opted-in or can manually opt-in to other information exchanges, including but not limited to manager messages and alerts (e.g., advertisements and critical event information).

In some embodiments, the system has preselected parameters, which users can alter, as desired. For example, the system may automatically discontinue alerts after an event ends, but may continue providing other information (e.g., advertisements) after this time period. A user may alter the default parameters to set the timing and termination of such information exchanges on any desired schedule.

In some embodiments, the systems and methods provide a user interface that allows particular users, such as event planners, event participants, and/or guests to select communications options, such as selecting the recipient list for communications sent by the user. For example, in some embodiments, event organizers can select a setting such that the event organizer's communications (e.g., alerts, advertising, or other communications) are sent to all event attendees instantaneously and simultaneously, but only attendees of one specific event at a specific time and location. In some embodiments, attendees can select options to communication with one another. In some such embodiments, communication are routed to all attendees or alternatively to a subset defined by the sender or to a subset that have elected to opt-in to such communications.

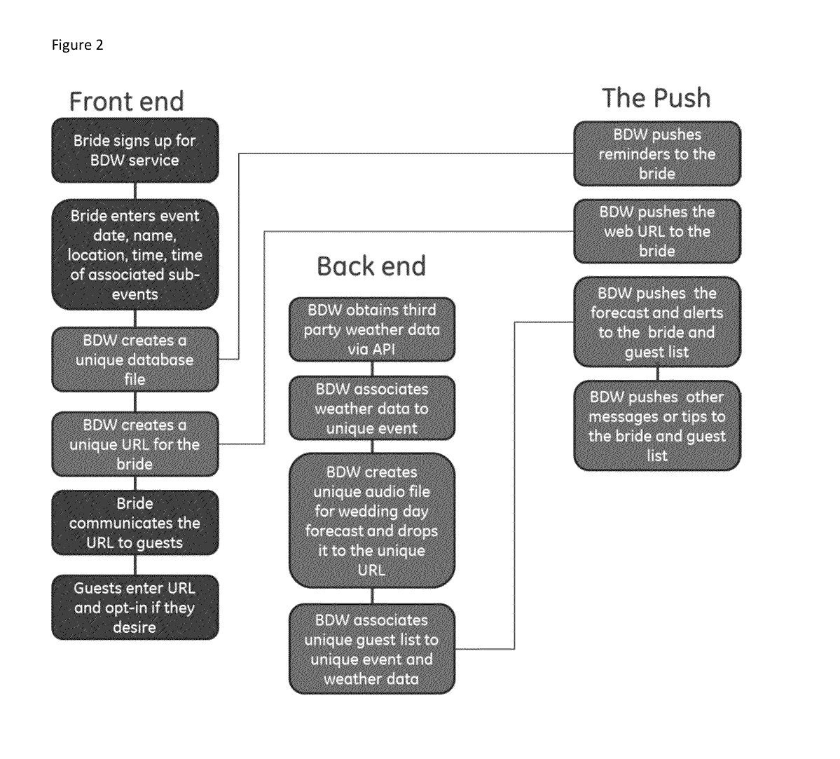

FIG. 2 depicts one embodiment of an implementation of the systems and methods. In this embodiment, an event or activity participant (e.g., a bride) transacts with a transaction service. The event participant enters event or activity data such as date, name, location, and time of the event and, sometimes, associated sub-events. In some embodiments, data is transmitted by the participant to the transaction service electronically (e.g., with a computer via the Internet) and/or through other means of communication between the participant and the transaction service (e.g., one or more in-person or telephone communications). Once data is received by the transaction service, the transaction service creates a unique electronic database file. This database file is used by the transaction service to send push reminders to the participant (e.g., text messages or phone calls) and to create a unique URL for the participant. This unique URL is delivered to the participant through a variety of means including a push. The participant then has the option of communicating the URL to other parties and to create a guest list. These parties use the URL to access the transaction service and opt-in to the service if they desire. In some embodiments, these parties participate in the service automatically unless they opt-out.

In some embodiments, the transaction service provides information such as weather data to the participant and those individuals designated by the participant. In some embodiments, the transaction service receives third party weather data via API and associates said weather data to one or more unique events and activities as specified by the participant. In some embodiments, the transaction service creates one or more unique audio or video files for weather forecasts for one or more events (e.g., a wedding) and provides this unique audio or video file to the unique URL. In some embodiments, the transaction service associates one or more unique guest lists to one or more unique events and weather data. In some embodiments, the transaction service pushes the forecast or forecasts and alerts to the participant and/or other designated parties. In further embodiments, the transaction service pushes other messages or tips to the participant and/or other designated parties.

In some embodiments, the communications to the participants and/or planners occurs via multiple methods including website communications, email, text, social media, or directly to an app. These communications can arrive at multiple devices including but in no way limited to computers, phones, smart phones, and tablet computers.

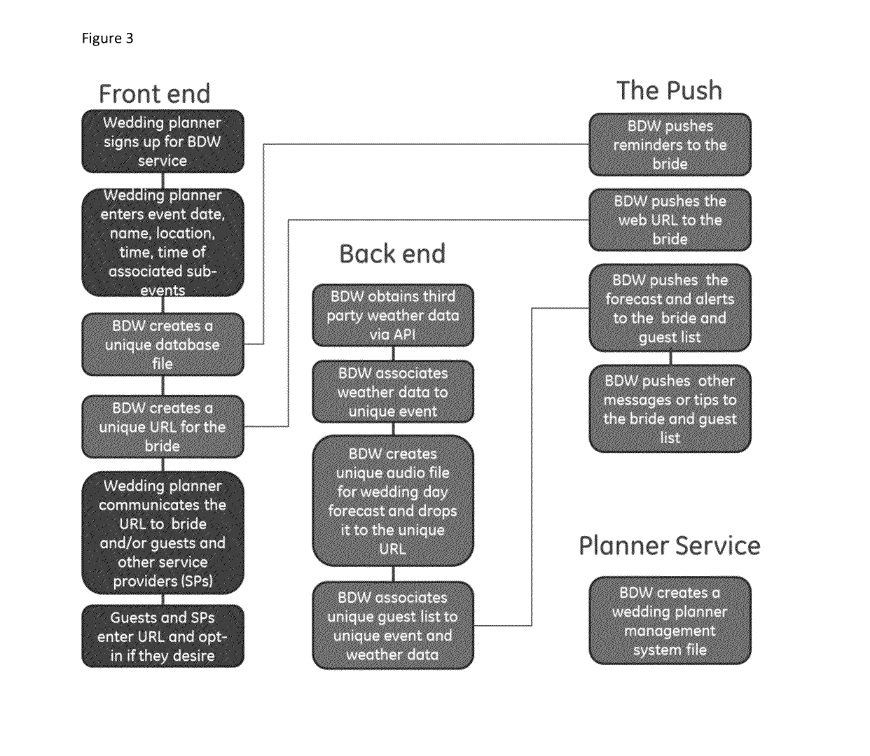

FIG. 3 depicts another embodiment of the systems and methods. In this embodiment, an event or activity planner (e.g., a wedding planner) transacts with a transaction service. The event planner enters event or activity data such as date, name, location, and time of the event and of associated sub-events. In some embodiments, the data is transmitted to the transaction service electronically (e.g., with a computer via the internet) and/or through other means of communication between the planner and the transaction service (e.g., one or more in-person or telephone communications). Once data is received by the transaction service, the transaction service creates a unique electronic database file. This database file is used by the transaction service to send push reminders (e.g., text messages or phone calls) to the event planner and other designated individuals and to create a unique URL for the planner. This unique URL is delivered to the event planner or participant through a variety of means including a push. The planner then has the option of communicating the URL to other parties. These parties use the URL to access the transaction service and opt-in to a service if they desire. In some embodiments, these parties participate in the service automatically unless they opt-out.

In some embodiments, the transaction service provides information such as weather data to the event planner. In some embodiments, the transaction service receives third party weather data via API or other methods, and associates said weather data to one or more unique events and activities as specified by the planner. In some embodiments, the transaction service creates one or more unique audio or video files for weather forecasts for one or more events (e.g., a wedding) and provides this unique audio or video file to the unique URL. In some embodiments, the transaction service associates one or more unique guest lists to one or more unique events and weather data. In some embodiments, the transaction service pushes the forecast or forecasts and alerts to the planner and/or other designated individuals. In further embodiments, the transaction service pushes other messages or tips to the planner and/or other designated parties.

In some embodiments, the event planner is able to invite service providers (e.g., florists and photographers) to opt-in to the transaction service text or email pushes. The transaction services then provides said pushes containing weather forecasts, severe weather alerts, messages, and/or other communications to the service providers. In some embodiments, the planner is also able to create messages pertaining to one or more events for the service providers. In further embodiments, the transaction service creates an event planner management URL which contains a subset of the master transaction service database that reflects the parent-child relationship of the event planner to the multiple events for which he or she is responsible.

In some embodiments, the push notification provided by the transaction service allows the event planner or the transaction service to create and/or push advertisements, messages, alerts, instructions, and any other communications to the list of attendees that have opted-in to the service. In some embodiments, this push option reflects the ability of the transaction service to contact attendees of a specific event at a specific location on a specific date at a specific time. In some embodiments, the push allows planners and the transaction service to react instantly or in a predetermined fashion to communicate emergency and non-emergency information including advertisements to the list of attendees. In further embodiments, the creation of messages occurs because the transaction service creates fields within its unique event database that are dynamic and capable of being added to with new information at any time. The creation of the messages can be programmed to push the messages to the attendee list at predetermined times or immediately.

In some embodiments, the communications to the participants and/or planners can occur via multiple methods including website communications, email, text, social media, or directly to an app. These communications can arrive at multiple devices including but in no way limited to computers, phones, smart phones, and tablet computers.

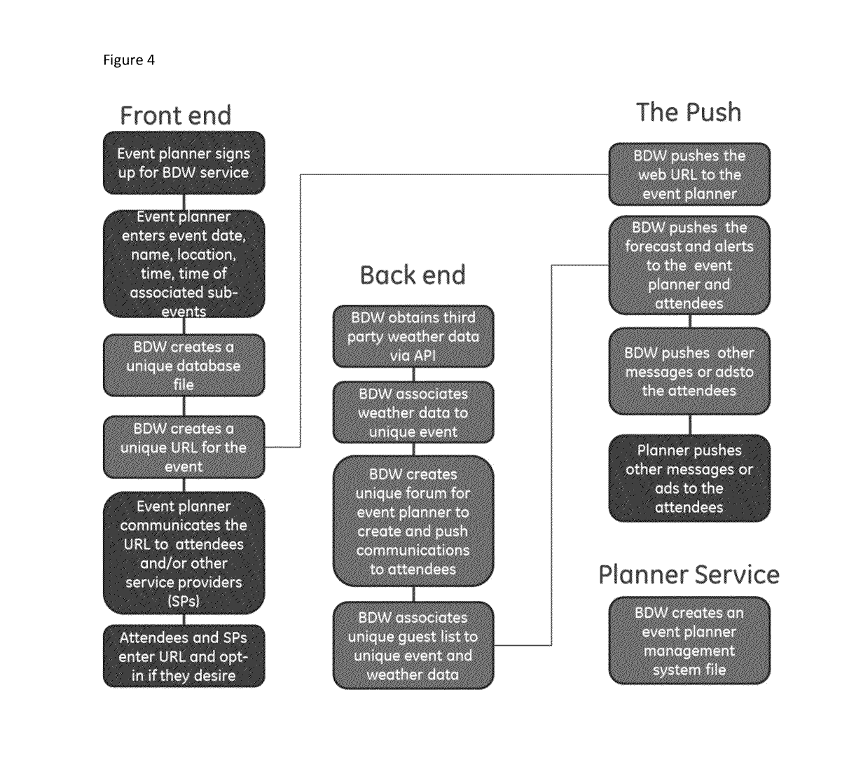

FIG. 4 depicts another embodiment of the systems and methods. In this embodiment, an event or activity planner (e.g., a concert promoter or sporting event manager) transacts with a transaction service. The event planner enters personalized event or activity data such as date, name, location, and time of the event and of associated sub-events. In some embodiments, the data is transmitted to the transaction service electronically (e.g., with a computer via the Internet) and/or through other means of communication between the planner and the transaction service (e.g., one or more in-person or telephone communications). Once data is received by the transaction service, the transaction service creates a unique electronic database file. This database file is used by the transaction service to send push reminders (e.g., text messages or phone calls) to the event planner and/or other designated individuals and to create a unique URL for the planner. This unique URL is delivered to the event planner and/or other designated individuals through a variety of means including a push. The planner then has the option of communicating the URL to other parties. These parties use the URL to access the transaction service and opt-in to the service if they desire. In some embodiments, these parties participate in the service automatically unless they opt-out.

In some embodiments, the transaction service provides information such as weather data to the event planner. In some embodiments, the transaction service receives third party weather data via API or other methods and associates said weather data to one or more unique events and activities as specified by the planner. In some embodiments, the transaction service creates one or more unique audio files for wedding weather forecasts for one or more events (e.g., a wedding) and provides this unique audio file to the unique URL. In some embodiments, the transaction service associates one or more unique guest lists to one or more unique events and weather data. In some embodiments, the transaction service pushes the forecast or forecasts and alerts to the planner or other designated individual. In further embodiments, the transaction service pushes other messages or tips to the planner, participant, guest list, and/or a combination of two or more parties.

In some embodiments, the event planner is able to deploy the push option to the event attendees by means such as printing the unique URL on a ticket, receipt, signage, or in a reminder email, text, or other form of communication. The event planner may choose to require attendees to opt-in to the push notifications. In some embodiments, the event attendees are able to opt-in via a response communication. In other embodiments, the event attendees are able to opt in by accessing the unique URL provided by the transaction service. In some embodiments, the event attendees are able to opt-in via a response text or by accessing the event's unique URL provided by the transaction service. In some embodiments, this URL is communicated to the event attendees by the event planner and/or the transaction service. In some embodiments, event attendees who opt-in to the transaction service receive weather forecasts, severe weather alerts, and other communications (e.g., cancellations, re-scheduling information, relocation of the event).

In some embodiments, the event planner is able to create messages accessible by the event's URL. Some implementations of the URL service provide the event planner with features unavailable to some other users. In some embodiments, the messages created by the planner are deployed immediately or at a predetermined time by the transaction service to those event attendees who opted-in to the transaction service. These messages may be delivered as pushes. In some embodiments, the messages include, but are not limited to, one or more of the following: advertisements, instructions during severe weather, recommendations for exit routes at the end of the event or activity, and promotions for subsequent events being promoted by the same or a different event planner.

In some embodiments, the push notification provided by the transaction service allows the event planner or the transaction service to create and/or push advertisements, messages, alerts, instructions, and any other communications to the list of attendees that have opted-in to the service. In some embodiments, this push option reflects the ability of the transaction service to contact attendees of a specific event at a specific location on a specific date at a specific time. In some embodiments, the push allows planners and the transaction service to react instantly or in a predetermined fashion to communicate emergency and non-emergency information including advertisements to the list of attendees. In further embodiments, the creation of messages occurs because the transaction service creates fields within its unique event database that are dynamic and capable of being added to with new information at any time. The creation of the messages can be programmed to push the messages to the attendee list at predetermined times or immediately.

In some embodiments, the communications to the participants and/or planners occur via multiple methods including website communications, email, text, social media, or directly to an app. These communications can arrive at multiple devices including but in no way limited to computers, phones, smart phones, and tablet computers.

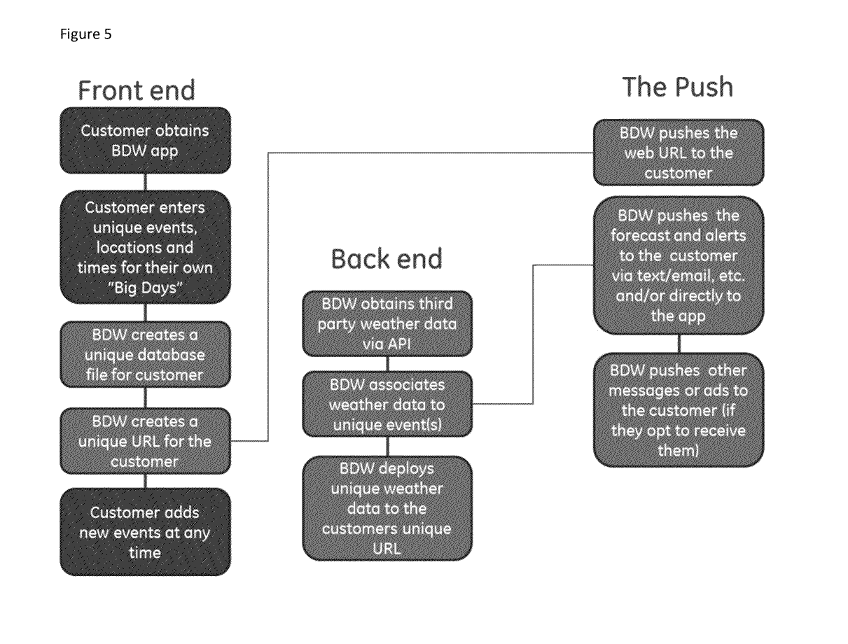

FIG. 5 depicts another embodiment of the systems and methods. In this embodiment, an individual begins a transaction with a transaction service. The individual enters event or activity data such as date, name, location, and time of the event and of associated sub-events. The individual may also choose to enter more than one event or associated sub-event. In some embodiments, the data is transmitted to the transaction service electronically (e.g., with a computer via the Internet) and/or through other means of communication between the individual and the transaction service (e.g., one or more in-person or telephone communications). Once data is received by the transaction service, the transaction service creates a unique electronic database file. This database file can be used by the transaction service to send push reminders (e.g., text messages or phone calls) to the individual and to create a unique URL for the participant. This unique URL is delivered to the individual through a variety of means including a push. In some embodiments, the individual has the option of communicating the URL to other parties. In some embodiments, the individual uses the URL to access the transaction service and opt-in to the service if they desire. In some embodiments, these parties participate in the service automatically unless they opt-out.

In some embodiments, the transaction service provides information such as weather data to the individual. In some embodiments, the transaction service receives third party weather data via API or other methods, and associates said weather data to one or more unique events and activities as specified by the individual. In some embodiments, the transaction service creates one or more unique audio files for weather forecasts for one or more events and provides this unique audio file to the unique URL. In some embodiments, the transaction service associates one or more unique guest lists to one or more unique events and weather data. In some embodiments, the transaction service pushes the forecast or forecasts and alerts to the individual. In further embodiments, the transaction service pushes other messages or tips to the individual.

In some embodiments, the transaction service creates and maintains a database of customers, each with one or more unique event lists at one or more unique locations. In some embodiments, the transaction service facilitates the distribution of weather or other information to these customers by creating unique weather information pushes that are derived from weather data, the unique location of the customer's event, the unique time of the customers' event, or other sources. In some embodiments, customers have the ability to opt-in to receive advertisements associated with the events that they indicate. In some embodiments, these advertisements include information from an event manager or business that advertises with the transaction service. In some embodiments, customers who opt-in to the advertisements are not be required to pay for the transaction service while customers who opt-out are required to pay. In some embodiments, purchasing an app from the transaction service allows the customer to opt-out of the advertisements. In some embodiments, a transaction service app is free to customers if they opt-in to receive advertisements.

In some embodiments, the communications to the participants and/or planners occur via multiple methods including website communications, email, text, social media, or directly to an app. These communications can arrive at multiple devices including but in no way limited to computers, phones, smart phones, and tablet computers.

### Example 1

In this embodiment, the systems and methods are used to provide personalized weather forecast information to a bride and other wedding guests. The systems and methods are used to facilitate transactions for a variety of types of customers including but not limited to activity coordinators, event planners, wedding guests, and other individuals as well as a variety of different activities including but not limited to weddings, gatherings, and outings.

In this embodiment, an individual who anticipates an event of some sort, such as a bride anticipating a wedding, purchases services in one or more of several categories including but not limited to:
a) An audio forecast on the day of the event (e.g., the wedding).
b) An audio forecast plus access to a digital (web-based) personalized forecast that originates prior to the event (e.g., 14 days, 2 months, or another specified time) and includes the ability for the event or activity guests to access a unique web address associated with the customer and/or event or activity in order to opt-in to a service which will push text, email, or other types of messages to the guest list. These messages can include one or more of the following: weather forecasts, personalized weather forecasts, severe weather alerts, greetings, reminders, important event information, instructions, weather related tips, and other information.
c) Access to a live meteorologist who is on-call during a specified day (e.g. the day of the event) on behalf of the customer. The customer may make one or more calls as specified by the transaction service to the meteorologist before and including the event day. In some embodiments, the customer is permitted a preset number of calls (e.g., two, three, etc.) to the meteorologist up to two days before and including the day of the event.
   In some embodiments, a customer who chooses one of the services described herein is able to send a unique URL to his or her guest list. Upon accessing the website described by the URL, the guests of the customer are directed to the customer's unique URL and decide to opt-in to the service. The guest or guests opt-in by selecting a medium for communication including but not limited to email, text, and telephone. Those guests who opt-in are associated with the customer's event day, location, and unique URL. The transaction service is then able to deliver messages to the guests individually, as a group known as the guest list, or to a sub-group.

### Example 2

In this embodiment, the customer is an individual or organization, herein referred to as a “planner,” who in some way organizes or coordinates resources for an event or activity. In this embodiment, the transaction service provides or sells one of the following services to the planner:
a) An audio forecast on the day of the event (e.g., a wedding, banquet, or sporting event).
b) An audio forecast plus access to a digital (web-based) personalized forecast that originates prior to the event (e.g., 14 days, 2 months, or 1 year) and includes the ability for the event or activity guests to access a unique web address associated with a customer, planner, and/or event or activity in order to opt-in to a service which will push text, email, or other types of messages to a guest list. These messages can include one or more of the following: weather forecasts, personalized weather forecasts, severe weather alerts, greetings, reminders, important event information, instructions, weather related tips, and other information.
c) Access to a live meteorologist who is on-call during a specified day (e.g. the day of the event) on behalf of the customer. The customer may make one or more calls as specified by the transaction service to the meteorologist before and including the event day. In some embodiments, the customer is permitted a preset number of calls (e.g., two, three, etc.) to the meteorologist up to two days before and including the day of the event.
   In some embodiments, the planner purchases one or more of the above services and resells the service to the planner's clients and/or customers. In some embodiments, the transaction service makes push options available to the planner, client, or other customer. The planner is also able to invite additional service providers (e.g., DJs, florists, photographers, and caterers) to opt-in to the pushes. In some embodiments, the pushes include personalized weather forecasts, severe weather alerts, and other messages. In some embodiments, the planner is able to create and send messages to his or her service providers. Such messages could be used for a variety of purposes including but not limited to organizing sub-events, changing times, and changing locations. In some embodiments, the push notices are associated with a single event at a location or locations for a discreet audience. In some embodiments, the transaction service also creates planner management URLs which contain a subset of a master database that reflects the relationship of the planner to multiple events.

### Example 3

In this embodiment, the customer is an event or activity planner such as a concert promoter or sporting event manager. In this embodiment, the customer elects to deploy text, email, or other types of push options to event attendees by means such as printing the unique URL on a ticket, receipt, signage, or in a reminder email, text, or other form of communication. The customer may decide to require attendees to opt-in. In some embodiments, event attendees are able to opt-in via methods such as sending a response text or accessing the event's unique URL provided by the customer and/or transaction service. In some embodiments, this unique URL is provided by the transaction service, and the URL directs individuals to a website associated with a unique event. In some embodiments, the information for this unique website is provided by a customer such as an activity planner, event manager, or concert promoter.

In some embodiments event attendees who opt-in to the service provided by the transaction service receive personalized weather forecasts, severe weather alerts, general weather forecasts, event information, and other communications. In some embodiments, the customer is able to create messages and communications and send them instantly or at a predetermined time to those attendees that opted-in to the transaction service. These communications can include, but are not limited to, the following: advertisements, instructions during severe weather, recommendation for exit routes before, during or following an event, or promotions for other events being promoted, organized, or influenced by the customer.

### Example 4

In this embodiment, the transaction service creates an app that allows customers the ability to input information including, but not limited to, events the customer wishes to attend, events the customer intends on attending, events the customer is organizing, events the customer is monitoring, events the customer is promoting, and events in which the customer is interested. In some embodiments, the app allows customers to receive weather forecasts, severe weather alerts, and other communications in the days prior to and on the day of the events input into the app. In some embodiments, the transaction service creates and maintains a database of customers, some or all of these customers having unique event lists at unique locations. In certain embodiments, the transaction service facilitates the distribution of information, including but not limited to weather information, to one or more customers by creating unique weather information pushes that are derived from weather data, the location (unique or otherwise) of the customer's event, and the time of the customer's event. In some embodiments, customers are able to opt-in to receive advertisements associated with the events that they input into the app (e.g., advertisements from an event manager or from nearby businesses). In some embodiments, the customer is able to opt-out of the advertising service and thereby be excluded from advertisements. In some embodiments, the app is free to customers who opt-in to the advertisements whereas customers who opt-out generally pay to use the app.

We claim:

1. A method for facilitating event planning comprising:
a. establishing a transactional relationship with a customer,
b. soliciting information regard a date, time, location, and guest list for a future event from said customer,
c. storing the solicited information in a database,
d. associating the solicited information with a URL,
e. providing one or more individuals on the guest list with the URL,
f. permitting said one or more individuals to use the URL to opt-in to a service plan, and
g. delivering information related to the future event to one or more or all of the individuals that opt-in.

2. The method of claim 1 wherein the transactional relationship is established using an app or web site.

3. The method of claim 1 wherein the information sent to individuals who opt-in include one or more of the following: weather forecasts, severe weather alerts, advertisements, instructions, and pictures.

4. A method of providing personalized weather information comprising:
a. soliciting personalized date, time, and location information about a future event from a customer,
b. associating the information with the customer or another individual designated by the customer,
c. storing of the personalized information in a database,
d. aggregating weather forecast information related to the future event information provided by the customer, and
e. disseminating the weather forecast information to said customer or one or more individuals designated by said customer.

5. The method of claim 4 wherein the event is a wedding, sporting event, concert, party, or gathering.

6. The method of claim 4 wherein the weather forecast information is obtained from a meteorologist, database, or algorithm.

7. The method of claim 4 wherein said one or more individuals opt-in to receive the disseminated information by email, text message, social networking site, or directly using an app.

8. The method of claim 4 wherein the weather forecast information is disseminated by email, pushes, text messages, and telephone communications.

9. The method of claim 4 wherein a meteorologist is available to speak with and provide weather forecast information to said customer on and before the event day.

10. A method of providing personalized weather information comprising:
a. obtaining personal information related to a future event including a date, time, and location from a client,
b. associating the information with a URL,
c. informing the client of the URL related to the information,
d. allowing individuals who access the URL to opt-in to notifications,
e. using the information in conjunction with a meteorologist and/or weather database to develop a personalized weather forecast, and
f. sending the personalized weather forecast to the client and/or the individuals who opted-in to the notifications.

11. The method of claim 10 wherein the client entered the information in an app or web site.

12. The method of claim 10 wherein the notification is delivered with a push.

13. The method of claim 10 wherein the future event is a wedding, concert, party, or gathering.

14. The method of claim 10 wherein the other information includes advertisements, instructions, emergency weather alerts, and exit route suggestions.
